(19) United States
(12) Patent Application Publication
(10) Pub. No.: US 2021/0407490 A1
(43) Pub. Date: Dec. 30, 2021

(54) METHOD AND SYSTEM FOR FACILITATING GROUP COMMUNICATION OVER A WIRELESS NETWORK

(71) Applicants: Jorge Cardoso, Wellington, FL (US); John W. Scandrett, Wellington, FL (US)

(72) Inventors: Jorge Cardoso, Wellington, FL (US); John W. Scandrett, Wellington, FL (US)

(21) Appl. No.: 17/357,622

(22) Filed: Jun. 24, 2021

Related U.S. Application Data
(60) Provisional application No. 63/045,464, filed on Jun. 29, 2020.

(51) Int. Cl. G10K 11/178; G10L 25/51; G06N 3/08; G06N 3/04

(52) U.S. Cl. CPC G10K 11/17823; G10K 11/17873; H04W 84/042; G06N 3/08; G06N 3/0454; G10L 25/51

(57) ABSTRACT

A communications enhancement computing system for connecting multiple users while balancing audio noise comprises a memory, a network interface device and a processor configured for applying signal processing techniques to a dataset of environmental sounds to extract sound characteristics of said sounds, executing a first deep neural network algorithm to train a first machine learning classification model for classifying sounds by label, executing a second deep neural network algorithm to train a second machine learning classification model for classifying sounds by environment, receiving, via the communications network, input sounds from a user and executing the first and second classification models to classify the input sounds by label and by environment, defining a sound softening technique configured to apply to audio from the user, wherein said sound softening technique is based on the environment and label, and executing the sound softening techniques to a continuous audio feed from the user.

### CROSS-REFERENCE TO RELATED APPLICATIONS

This patent application claims priority to provisional patent application 63/045,464 filed on Jun. 29, 2020 and titled “METHOD AND SYSTEM FOR FACILITATING GROUP COMMUNICATION OVER A WIRELESS NETWORK.” The subject matter of provisional patent application 63/045,464 is herein incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to electronic communications, and more specifically, the claimed subject matter relates to the field of electronic communications for groups using software and hardware devices.

### BACKGROUND

Communication in noisy or crowded spaces has long been the bane of consumers at large events or activities that require physical distance. While advancements in technology such as cell phones and walkie-talkies have provided aid in facilitating communication in these settings, the current state of such technology leaves much to be desired and generally fails in producing a user-friendly, easily accessible method of communicating therein. In many cases, consumers are left to their own devices to determine how to communicate, often resorting to yelling, retreating to quieter spaces, or at times simply forgoing communication until a more suitable environment is found or created. In addition, many consumers find themselves in situations where the desired outcome, an increased ability to listen and participate, cannot be achieved unilaterally. This burden is greater felt when participating in events, such as social events (at restaurants, clubs, bars, etc.), sporting events and entertainment events or conferences and rallies, where one may find themselves unable to hear friends, family, and/or announcers over the crowds and other background noises. These same issues arise in group activities requiring physical distance and other similar scenarios where participants may want to communicate but find it difficult or impossible to do so while still actively participating. As mentioned above, certain advancements have been made but they typically fail to consider the breadth of the issue and the unique circumstances in which one may find themselves needing to resolve said issues.

One major advancement in the space takes the form of noise-cancelling devices such as headphones and earphones. Noise-cancelling technology has become standard in the premium headphone market but does not resolve the present issues. This technology gives consumers the ability to turn on or off a noise-cancelling feature in their headsets in order to facilitate listening on a device without excessive interference from background noise. While this technology has become well known and utilized, it fails to consider many of the factors listed above and falls short in provided the solutions consumers are looking for. One major shortfall of the technology as it is presented on the market is the inability to automatically adapt to the user's unique environment. This is because the technology focuses heavily on improving the user's experience with media separate from the environment the user may be in rather than facilitating, and in fact at times preventing, participation in that environment.

Another shortfall of the present state of this technology is that it fails to shift from the active noise cancellation consideration to a noise or sound recognition consideration. While presently it may successfully cancel or neutralize unwanted background noise, it completely fails in allowing the user to identify certain aspects of the perceived background noise and except that from noise-cancellation. This issue is especially salient in the event that a user is attempting to communicate or receive communication in noisy spaces. For example, if a user is in a noisy restaurant is attempting to communicate with someone at their table, noise cancellation will attempt to cancel out or neutralize not only the noise coming from across the room, but also the “noise” coming from the participant with whom the user is attempting to communicate. This issue may also arise in sporting events where, as mentioned above, a commentator or referee's reports may be muffled by the sound of a roaring crowd. Alternatively, on a group run or cycling trip where participants may be physically distant, or roadway noise may be too loud to permit normal communication.

The currently existing technology further fails to provide the hosts of the above-mentioned events the ability to effectively connect and communicate with attendants or participants. Considering the example given above, sporting events such as football games see crowds producing noise on average between 80 and 90 decibels. This means that announcers, commentators, and referees must either yell in order to be heard through the sound system, an undesirable option considering the distortion that will result from the speaker, or simply go unheard. This leads to spectator uncertainty with regard to what they have seen and the progress of the event in which they are participating, frustration on the part of commentators and referees as they struggle or fail to communicate with one another as well as the audience, and to some consumers leaving frustrated after not being able to discern any announcements at all nor communicate amongst themselves at the event. The general issue is with the general population's frustrations to hear clearly what is being announced or not being able to talk with their friends or family at a loud event due to crowd noise. For example, a party of people attending a game or a bar, wherein one person cannot hear another person in the same party seated a few seats over.

As a result of the previously recognized issues, a need exists for a system that connects to headphone or earphone devices and allows user groups to easily communicate while automatically balancing the cancellation of undesirable noise with the need to communicate and receive desirable noise.

### BRIEF SUMMARY

In one embodiment, a system for facilitating group communication over a wireless communication network while balancing audio noise is disclosed. The communications enhancement computing system for connecting multiple users while balancing audio noise comprises a memory, a network interface device communicably coupled to a communications network, and a processor configured for: a) applying signal processing techniques to a dataset of environmental sounds to extract sound characteristics of said sounds; b) executing a first deep neural network algorithm to train a first machine learning classification model for classifying sounds by label; c) executing a second deep neural network algorithm to train a second machine learning classification model for classifying sounds by environment; d) receiving, via the communications network, input sounds from a user and executing the first classification model to classify the input sounds by label; e) executing the second classification model to classify the input sounds by environment; f) defining a sound softening technique, comprised of noise cancelling processes, configured to apply to audio from the user, wherein said sound softening technique is based on the environment and label that were calculated; and g) executing the sound softening techniques that were defined to a continuous audio feed from the user.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating group communication over a wireless communications network, in accordance with one embodiment.

FIG. 2 is a block diagram showing the data flow of the process for facilitating group communication over a wireless communications network, according to one embodiment.

FIG. 3A is a flow chart depicting the general control flow of a process for facilitating group communication over a wireless communications network, according to one embodiment.

FIG. 3B is a flow chart depicting the general control flow of a process for facilitating group communication over a wireless communications network while balancing audio noise, according to one embodiment.

FIG. 4 is a block diagram depicting a system including an example computing system and other computing devices.

### DETAILED DESCRIPTION

The disclosed embodiments improve upon the issues identified within the prior art by provided a system that connects to headphone or earphone devices and allows user groups to easily communicate in situations with high noise pollution while automatically balancing the cancellation of undesirable noise with the need to communicate and receive desirable noise. With a consumer as the end-user, the user may access the end-user application to create a private room that recognizes and maintains the volume of participant voices while drowning out or cancelling undesirable background noise and thereby facilitate effective communication in loud or busy spaces, or spaces and situations that require physical distance. Alternatively, the users may connect to the room associated with the event or business the users are attending, allowing them to engage with the environment around them while still being able to participate and hear important updates, messages, or promotions from the coordinator or host. Therefore, the disclosed embodiments reduce or eliminate the need for the consumers to forgo one aspect of their experience—communication in this context—in order to fully appreciate another aspect of their experience—the correspondence related to the event they are attending. The disclosed embodiments also facilitate a more engaging experience for the consumer, thereby increasing the value of participation in said events.

Considering the end-user as a business or event host, the disclosed embodiments improve over the prior art by allowing those in these situations to effectively communicate their messages, promotions, or updates to consumers by creating event rooms and extending the communication without an internet provider through the use of a wireless routing device. This also facilitates participation by those in a setting where the user may not normally be able to communicate due to language barriers or physical distance regardless of background noise. In these situations, the disclosed embodiments improve upon the issues identified with the prior art by providing public and private rooms that can identify the presence of participants using geolocation and allowing the host to engage with the consumers thereby. A business or an event host can broadcast announcements within a geolocation fence or area across all party rooms via voice or text. A business or an event host can broadcast announcements within a geolocation fence or area across all party rooms via voice or text. A business or an event host also can broadcast announcements to certain users that fit a demographical profile, or according to certain attributes defined in a user profile.

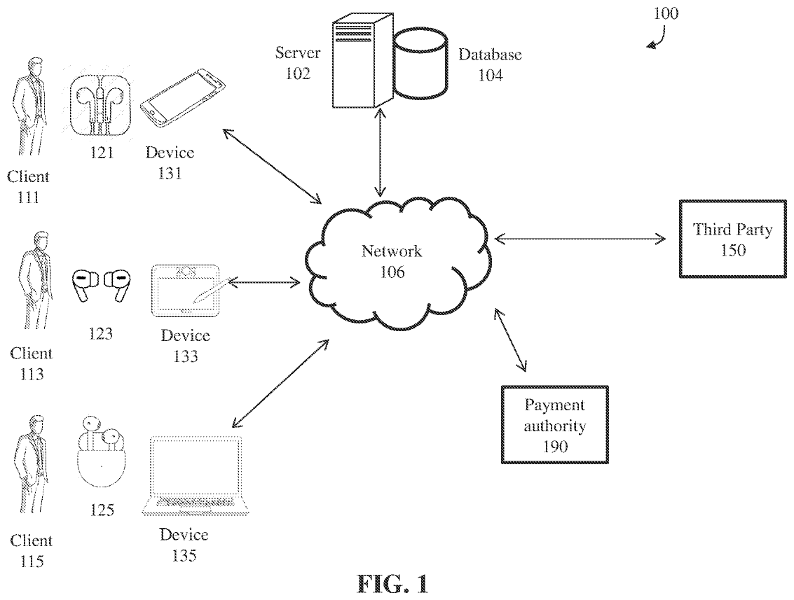

Referring now to the drawing figures in which like reference designators refer to like elements, there is shown in FIG. 1 an illustration of a block diagram showing the network architecture of a system 100 for facilitating group communication over a wireless communications network, in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating gift giving activities between users.

FIG. 1 includes mobile computing devices 131, 133 and 135, which may be smart phones, mobile phones, tablet computers, handheld computers, laptops, or the like. In addition, FIG. 1 includes portable audio devices 121, 123, and 125, which may be wired or wireless earphones or headphones. Mobile computing device 131 may correspond to a customer or client 111. Mobile computing devices 133 and 135 correspond to customers or clients 113 and 115. The terms customer or client are used loosely to designate any person or company utilizing the claimed embodiments. FIG. 1 also shows a server 102 and database or repository 106, which may be a relational database comprising a Structure Query Language (SQL) database stored in a SQL server. The repository 104 serves data from a database during the course of operation of the disclosed embodiments. Database 104 may be distributed over one or more nodes or locations that are connected via network 106.

The database 104 may include a user record for each customer or client 111, 113, or 115. A user record may include contact/identifying information for the user (username, given name, telephone number(s), email address, etc.), information related to the events the user is registered to participate in, contact/identifying information for friends or acquaintances of the user, electronic payment information for the user, sales transaction data associated with the user, etc. A user record may also include at any given moment location data about the user, a unique identifier for the user, and a description of past events attended, or locations visited by the user. A user record may further include demographic data for the user, such as age, sex, income data, race, color, marital status, etc.

Sales transaction data may include one or more product/service identifiers, one or more product/service amounts, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may further include a machine learning classification model for classifying input sounds by label (described in more detail below) and a machine learning classification model for classifying input sounds by environment.

FIG. 1 shows an embodiment wherein networked computing devices 131, 133, and 135 interact with server 102 and database 104 over the network 106. It should be noted that although FIG. 1 shows only the networked computers 131, 133, 135 and 102, the system of the disclosed embodiments supports any number of networked computing devices connected via network 106. Further, server 102, and units 131, 133, and 135 include program logic such as computer programs, mobile applications, executable files, or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131, 133, and/or 135. Further, server 102 and its functionality, according to a preferred embodiment, can be realized in a centralized fashion in one computer system or in a distributed fashion wherein different elements are spread across several interconnected computer systems. Additionally, the devices 131, 133 and 135 (or their functionality) may be integrated with the devices 121, 123, 125.

FIG. 1 also shows a payment authority 190, which acts to effectuate payments by users 111, 113, 115 or third party 150 for related services. In the course of a sales transaction, server 102 may interface with payment authority 190 to effectuate payment. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc.

FIG. 1 also shows a third-party 150, which represents an organization or business, or the host of an event. The third-party 150 may be a retail store, a restaurant, a cafeteria, a music venue, a sports venue, a theater, an arena, a stage, an amphitheater, an outdoor concert structure, stadium, bandshell, bandstand, concert hall, opera house, nightclub, discotheque, park, bar, pub, sports complex, etc.

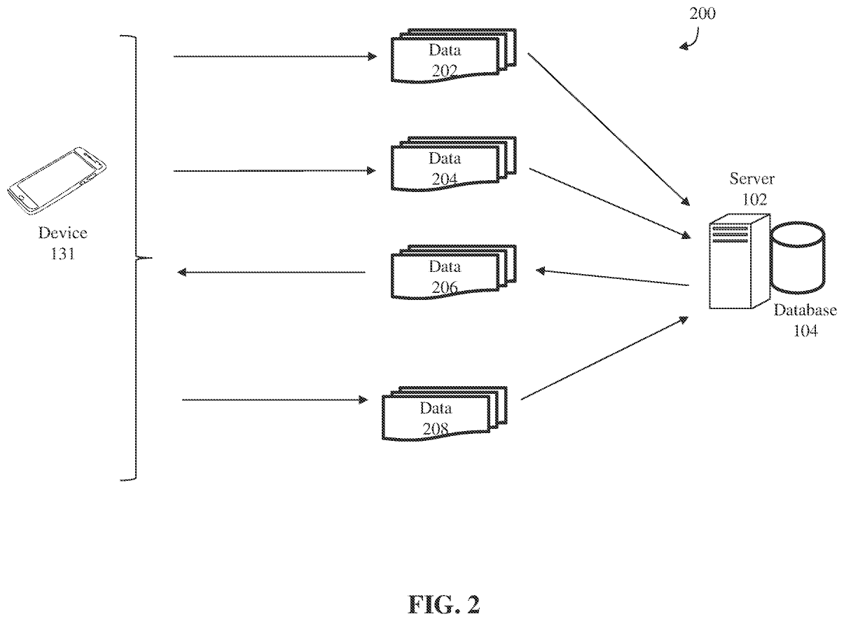

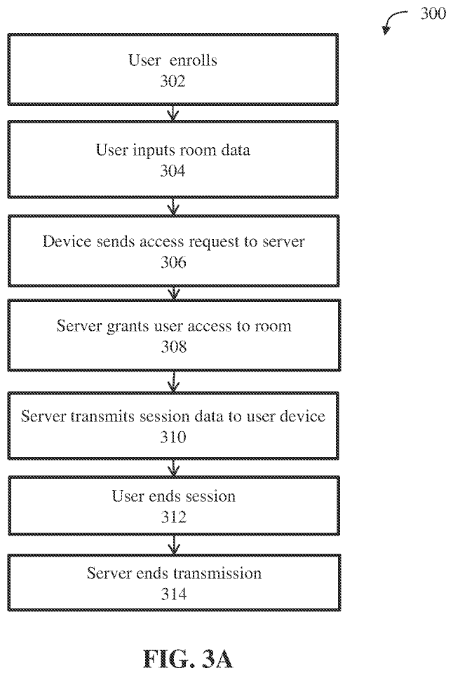

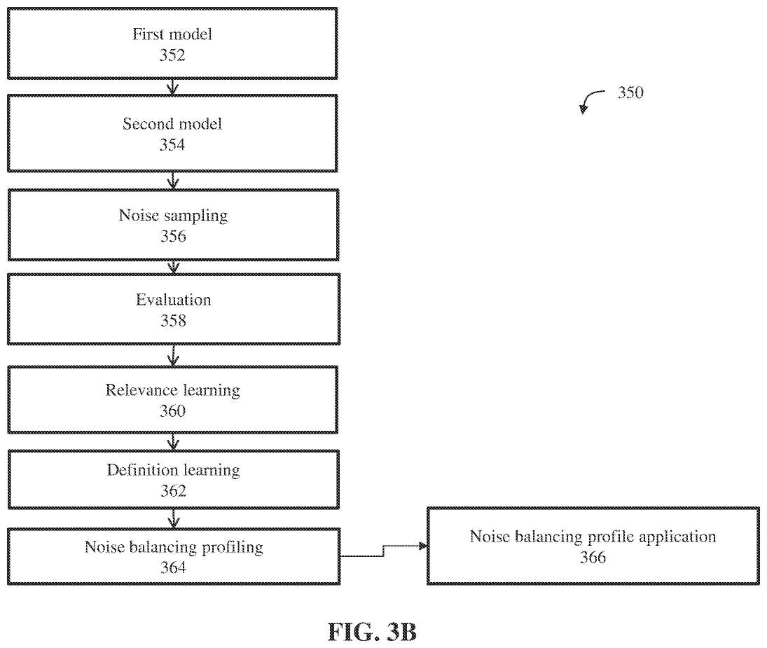

The process of facilitating group communication over a wireless communications network will now be described with reference to FIGS. 2-3A below. FIGS. 2-3A depict the data flow and control flow of the process for facilitating group communication over a wireless communications network 106, according to one embodiment. The process of the disclosed embodiments begins with step 302 (see flowchart 300, FIG. 3A), wherein the users 111, 113 and 115 may enroll or register with server 102 (via data packet 202). In the course of enrolling or registering, the users may enter data into their device by manually entering data into a mobile application via keypad, touchpad, or via voice. In the course of enrolling or registering, the users may enter any data that may be stored in a user record, as defined above. Also, in the course of enrolling or registering, the server 102 may generate a user record for each registering user and store the user record in an attached database, such as database 104.

Subsequently, in step 304, the user inputs into the mobile application the relevant data associated with the room or session the user would like to enter or create. The application is configured for transmitting a request 306 (via data packet 204 over network 106), such as an HTTP request, to server 102 to gain access to or create a room. In steps 308 and 310 respectively, the server verifies the credentials of the enrolled user and grants the user access to the room and transmits the room and session data to the user device (via data packet 206), which may include all audio related to the session within said room. This data may include audio data from an event host, advertisements, or other relevant data. Step 312 shows that once the user is finished participating in the room, the user ends the session or exits the room on the user's device. The user's device then sends termination data to the server in step 312 (via data packet 208) signaling that the session has ended, and in step 314 the server ends transmission.

In one embodiment, each device 121, 123, 125, 131, 133, 135 may be supplemented by a mobile hotspot device, which is a wireless access point (WAP) or a networking hardware device that allows other Wi-Fi devices to connect to a wired network. The mobile hotspot device may connect to the Internet or network 106 or may connect directly to third party 150. The mobile hotspot device may provide network monitoring functionality that detects optimal communication connections and switches to the most optimal network connection, private room functionality that creates rooms and invites guests to participate in the rooms, as well provide 175 feet of quality private WiFi connections. The mobile hotspot device may provide wireless connection in areas without the need for an Internet provider and will switch automatically to an optimal communication network based on signal strength and wireless communication speed.

The server 102 or third party 150 may provide advertising or messaging to prospective customers or patrons via the claimed embodiments. Said features may include on premise only communication to private rooms of the users, a client interface for the users, custom advertising or messaging to private groups, and text and voice messaging for the users.

In one embodiment, each device 121, 123, 125, 131, 133, 135 may be supplemented by providing the following functionality for hosts of a room: noise information functionality, noise balancing functionality, wireless routing device control functionality, client interface functionality, private room functionality, and network monitoring functionality. In one embodiment, each device 121, 123, 125, 131, 133, 135 may be supplemented by providing the following functionality for guests of a room: noise information functionality, noise balancing functionality, client interface functionality, and network monitoring functionality.

In one embodiment, each device 121, 123, 125, 131, 133, 135 may be supplemented by providing the following functionality: automatic adaptive noise balancing features along with physical image recognition through a machine learning system that will identify and learn each user's environmental surroundings based on sound and visual recognition technology, as well as apply an environmental profile to create optimal voice clarity over unwanted background noise. The feature makes it possible to hear and understand the user's private group conversations despite noisy environmental settings; therefore, enhancing the users' experience with groups of friends, family and/or co-workers, etc. In one embodiment, each device 121, 123, 125, 131, 133, 135 may be supplemented by providing language translation functionality, which may be provided by the device itself, by a third-party provider or which may be provided by the server.

In one embodiment, the server 102 may include a machine learning subsystem that detects noise patterns in environments and filters out noise so as to facilitate communication between users of the system 100. A sound relevance learning system identifies and learns negative background noise and determines sound softening level so that users of the system 100 can comfortably talk. A noise definition learning system automatically learns to identify negative noise for future reference and softening. A sound or noise identification system identifies and separates specific sounds and noise collected during each use of the system 100. A noise balancing profile system processes all defined sounds and determines how and when to include or exclude artifacts based on situational relevance. In one embodiment, the devices 121, 123, 125, 131, 133, 135 may include a noise information collection system that listens to and identifies the environment and transmits a setting recommendation to the server 102. The user may provide confirmation of said setting. A noise balancing system applies proper noise balancing profile defined by the user or the system 100.

FIG. 3B is a flow chart depicting the general control flow of a process for facilitating group communication over a wireless communications network 106 while balancing audio noise, according to one embodiment. The following description describes steps performed by server 102, though in different claimed embodiments, said steps may be performed by the server 102, the device of the user whose audio is being processed (such as devices 131, 133, 135) or any combination of the above.

In a first step 352, the server 102 may assemble a dataset of predefined environmental sounds and may apply one or more signal processing techniques to extract sound characteristics (frequency, magnitude, modulation, wavelength, etc.). The server then may use a deep neural network (DNN) algorithm to train and fine tune an initial machine learning classification model that is the initial model users will have available without providing new samples and performing further training. A DNN is an artificial neural network with multiple layers between the input and output layers. The components include neurons, synapses, weights, biases, and functions. Said components function similar to the human brain and can be trained like a machine learning algorithm. Classification is a technique data is categorized into a given number of classes. A classification model is used to draw conclusions from input values given for training. A classification model can therefore predict the class labels or categories for the new input data. Classification models include logistic regression, decision tree, random forest, gradient-boosted tree, multilayer perceptron, one-vs-rest, and Naive Bayes.

Examples of the signal processing techniques used to extract sound characteristics include principal component analysis (PCA), band filters, Fourier transforms, etc. PCA is a statistical technique whose purpose is to condense the information of a large set of correlated variables into a few variables (“principal components”), while still considering the variability present in the data set. A bandpass filter is a technique that passes frequencies within a certain range and rejects (attenuates) frequencies outside that range. A Fourier transform is a mathematical transform that decomposes functions depending on space or time into functions depending on spatial or temporal frequency, such as the expression of an audio clip in terms of the volumes and frequencies of its constituent sounds.

In a second step 354, the server 102 may use another DNN algorithm to train and fine tune a separate machine learning classification model to determine the environment the user is in. This classification model learns and saves particular sounds and associated environments where sounds are produced, then classifies said sounds by usage and relevance. An initial model will be created with an initial dataset, that will evolve as users send more sounds and environment samples. Initially, the server 102 may assemble a dataset of predefined environmental sounds and may apply one or more signal processing techniques to extract sound characteristics. This classification model is trained to evaluate a sound or sounds and generate an environmental label that defines the user's environment, such as bar, restaurant, outdoors, etc.

In a third step 356, the server 102 may automatically collect noise samples from the user's (111, 113, 115) environment with location information (using location-based services) as provided by the user's device (131, 133, 135). Sound sample files will be used to enhance the dataset and model for both classification models previously mentioned.

In a fourth step 358, the server 102 processes the sound sample files using the signal processing algorithms above to extract characteristics to be evaluated by one or more of the classification models above. Said process includes at least separating specific frequencies and classifying them with corresponding sound labels. Examples of labels are people chattering, music, road traffic, TV/PA sounds, etc. The classification model(s) will apply certain labels only if there is enough confidence in the DNN evaluation. If there is not enough confidence, the sound sample file will be escalated to human classification, where two actions might be taken: 1) there is already a proper label for that sample or 2) the sample is merged with the dataset using said label. A new label would be created, and that sample is added to the model.

In a fifth step 360, the server 102 may define the type of environment of the user based on a combination of the location information provided and types of sound found in the sample. The relevance of each classified sound for the environment location is generated. An example would be: people chattering—low relevance, music—medium relevance, TV sound—medium relevance, road traffic—no relevance, etc. Once again, if there is not enough confidence in the environmental evaluation, the sample will be escalated to human classification, where two actions might be taken: 1) there is already an environment for that sample or 2) the sample is merged with the dataset for that environment. A new environment would be created, and that sample is added to the model. User feedback from the last stage of the process may be considered in updates to create new environments and sound relevance.

In a sixth step 362, the server 102 may use the provided location information and the classified sounds to apply percentages of sound softening using reverse wave noise cancelling technology for each type of sound, creating a specific configuration or profile for each discovered and defined environment. For example, for a sports bar environment, the TV/PA sound softening is processed at 25%, the people chattering sound is softened by 90%, the music sound is softened by 50%, and the road traffic sound is softened by 100%. Sound softening refers to the removal or demotion or partial removal of a particular type of sound from a sample. Reverse wave noise cancelling refers to active noise control (ANC), also known as noise cancellation (NC), or active noise reduction (ANR), which is a method for reducing unwanted sound by the addition of a second sound specifically designed to cancel the first.

All the environments identified, and their configurations or profiles, may be stored in a database (such as 104) and dynamically updated by the models defined herein. User feedback from the last stage of the process may be considered in the noise definition process.

In a seventh step 364, the server 102 may store the noise balancing profile with the environment specific sound softening configuration in database 104. Different and specific noise cancelling configuration files may be created and stored in the database 104 for each homologated noise canceling device manufacturer.

In an eighth step 366, the server 102 may automatically push (using push technology) the configuration profiles to the local mobile application on each user's device (131, 133, 135). The configuration profiles are dynamically applied once a private room is created/started, setting the noise cancelling device with the respective configuration for the specific environment. Users will have the ability to switch between existing and downloaded profiles that are compatible with their noise canceling devices. In combination with the aforementioned technology applications, clear and uninterrupted communications amongst two or more people in noisy environments is possible with the claimed embodiments.

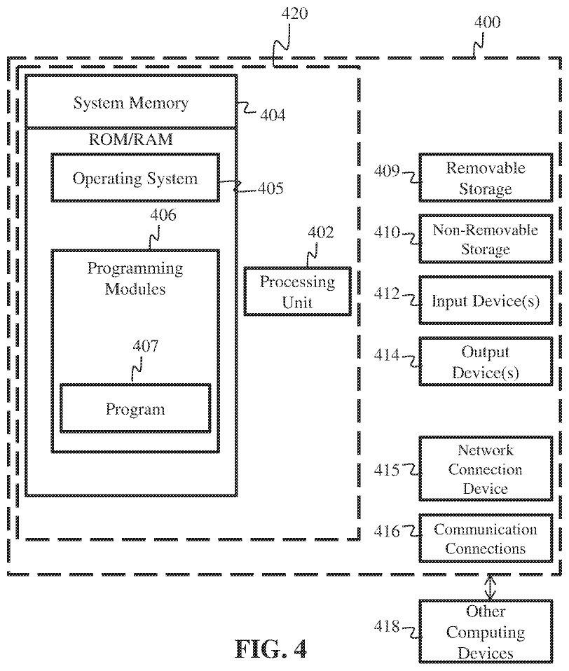

FIG. 4 is a block diagram of a system including an example computing device 400 and other computing devices. Consistent with the embodiments described herein, the aforementioned actions performed by devices 121, 123, 125, 131, 133, 135, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of devices 121, 123, 125, 131, 133, 135, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A communications enhancement computing system for connecting multiple users while balancing audio noise, the computing system comprising:
a memory;
a network interface device communicably coupled to a communications network; and
a processor configured for:
a) applying signal processing techniques to a dataset of environmental sounds to extract sound characteristics of said sounds;
b) executing a first deep neural network algorithm to train a first machine learning classification model for classifying sounds by label;
c) executing a second deep neural network algorithm to train a second machine learning classification model for classifying sounds by environment;
d) receiving, via the communications network, input sounds from a user and executing the first classification model to classify the input sounds by label;
e) executing the second classification model to classify the input sounds by environment;
f) defining a sound softening technique, comprised of noise cancelling processes, configured to apply to audio from the user, wherein said sound softening technique is based on the environment and label that were calculated; and
g) executing the sound softening techniques that were defined to a continuous audio feed from the user.

2. The system of claim 1, wherein the sound characteristics include frequency, magnitude, modulation, and wavelength.

3. The system of claim 2, wherein the label includes sound type, including people chattering and traffic.

4. The system of claim 3, wherein the environment includes location type, including outdoors and restaurant.

5. The system of claim 4, wherein the step of receiving, via the communications network, input sounds further comprises receiving, via a cellular network, input sounds.

6. The system of claim 5, wherein the step of executing the second classification model to classify the input sounds by environment results in an environmental label.

7. The system of claim 6, wherein the noise cancelling processes include active noise control processes.

8. The system of claim 7, wherein the continuous audio feed from the user is provided over the cellular network.

9. A communications enhancement computing system for connecting multiple users while balancing audio noise, the computing system comprising:
a memory;
a network interface device communicably coupled to a communications network; and
a processor configured for:
a) applying signal processing techniques to a dataset of environmental sounds to extract sound characteristics of said sounds;
b) executing a first deep neural network algorithm to train a first machine learning classification model for classifying sounds by label;
c) executing a second deep neural network algorithm to train a second machine learning classification model for classifying sounds by environment;
d) receiving, via the communications network, input sounds from a user and executing the first classification model to classify the input sounds by label;
e) executing the second classification model to classify the input sounds by environment;
f) defining a sound softening technique, comprised of active noise control processes, configured to apply to audio from the user, wherein said sound softening technique is based on the environment and label that were calculated; and
g) executing the sound softening techniques that were defined to a continuous audio feed from the user.

10. The system of claim 9, wherein the sound characteristics include frequency, magnitude, modulation, and wavelength.

11. The system of claim 10, wherein the label includes sound type, including people chattering and traffic.

12. The system of claim 11, wherein the environment includes location type, including outdoors and restaurant.

13. The system of claim 12, wherein the step of receiving, via the communications network, input sounds further comprises receiving, via a cellular network, input sounds.

14. The system of claim 13, wherein the step of executing the second classification model to classify the input sounds by environment results in an environmental label.

15. The system of claim 14, wherein the noise cancelling processes include active noise control processes.

16. The system of claim 15, wherein the continuous audio feed from the user is provided over the cellular network.
